(19) United States
(12) Patent Application Publication
(10) Pub. No.: US 2013/0251545 A1
(43) Pub. Date: Sep. 26, 2013

(54) MODULAR AIR DISCHARGE SYSTEM

(71) Applicant: Daniel J. VanderPyl, Brea, CA (US)

(72) Inventor: Daniel J. VanderPyl, Brea, CA (US)

(21) Appl. No.: 13/841,179

(22) Filed: Mar. 15, 2013

Related U.S. Application Data
(63) Continuation of application No. 13/185,802, filed on Jul. 19, 2011.

(51) Int. Cl. B05B 1/02

(52) U.S. Cl. CPC B05B 1/02
USPC 417/53; 239/590; 417/321

(57) ABSTRACT

An air discharge apparatus such as an air nozzle manifold comprises an elongated air distribution enclosure having an air supply inlet and an elongated air discharge slot. There is at least one removable insert, and generally multiple removeable inserts in the discharge slot. At least one of the inserts has a discharge opening for discharge of air from the enclosure where air can pass through the slots substantially only through the discharge openings.

### BACKGROUND

Throughout a wide range of industries and manufacturing processes, air knives and air nozzle manifolds have been used for decades to deliver pressurized air, which is generated by an air mover, i.e., a fan, blower or compressor, to blow against the surface of stationary or moving objects to remove liquid or debris from or to cool or to heat the surface of those objects. See for example U.S. Pat. Nos. 6,898,867 and 6,990,751 for which I am an inventor. The most common applications for air knives or air nozzle manifolds is when products, during certain processes of conveyorized manufacturing, must be cleaned, cooled, lubricated or warmed with water or other liquid which then must blown off using air knives or air nozzle manifolds with their high velocity non-contact air streams needed to ready the products for their next manufacturing process. Typically a fan or blower is the air mover when the air knife or nozzle pressures are less than 10 psig. A compressor is used as the air mover when the required air knife or nozzle pressures are between 10 psig and 100 psig.

An air knife consists of a manifold or plenum from which an elongated narrow air slot, either continuous or segmented, has pressurized air exiting from it in a laminar flow pattern across the length of the air slot. Air knives are generally best suited for operation within close proximity of the part being blown off and where any interruption in the continuous air flow may be detrimental to the blow off effect

An air nozzle manifold consists of a manifold or plenum from which multiple air nozzles, with round or elongated openings, are placed at various intervals along the length of the manifold. The air nozzle manifold does not provide a continuous laminar air flow along its length as does an air knife. Each orifice of the nozzles delivers a much larger air flow in a concentrated area than does an air knife and is therefore capable of projecting high velocity air streams from each nozzle for distances which are three to four times greater than an air knife for the same relative electric power to the air mover.

Previous designs of air nozzle manifolds have an air plenum or header comprised of either a round, square or formed metal or plastic shape, to receive the air from the air mover via a pipe, duct or hose. The air header also serves as the rigid mounting point for all of the externally mounted air nozzles protruding from the body of the air header. Attachment of the air nozzles to the header is either by means of threaded ports, hose barbs or weld points. Most of the finished air nozzle manifold designs are single purpose built with little or no adjustment possible in the diameter, center distance or angle of the nozzles.

In some designs, flexible hose connection between the air header and the nozzles has been used to facilitate nozzle adjustments. However, these nozzles with flex hose increase the overall size of the air nozzle manifold assembly. Also the flex hoses reduce effectiveness due to air friction losses, and it is difficult to retain the air nozzles in a fixed position for consistent air blow off results.

Therefore there is a need to have more flexibility in the operation of air nozzle manifolds to adapt for changing applications of the manifold than is possible with current designs.

### SUMMARY

The present invention provides a system that satisfies this need. The system includes an air discharge apparatus that comprises an elongated air distribution enclosure such as a plenum having an air supply inlet and an elongated air discharge slot. At least one removeable insert is in the discharge slot and at least one of the inserts has at least one discharge opening for discharging air from the enclosure where air can pass through the slot substantially only through discharge openings. The discharge openings have an inlet and an outlet. Because the inserts are removable, the system is modular, being easily adapted for different manufacturing conditions.

Spacing between the discharge openings can be controlled by using spacer inserts that have no discharge openings. A single insert can have multiple discharge openings. Typically the direction of discharge of the discharge openings is not adjustable to change the direction of discharges. Thus typically it is necessary to replace an insert to achieve a change in direction of air flow. A single insert can have multiple openings, where some of the openings discharge at different angles. Also a first insert can have an opening discharging at a first angle and a second insert can have an opening discharging at a second angle, the first and second angles being different.

Preferably the enclosure has exterior walls that taper towards each other proximate to the discharge slot. The inserts preferably are sized to fit between the exterior walls proximate to the discharge slot without being able to fit through the discharge slot. The inserts can be held in place by one or more releasable clamps or screws.

Preferably the discharge openings are tapered such as by uniformly decreasing the cross sectional area from the inlet to the outlet.

In use of the apparatus, at least one insert is removably placed in the discharge slot, where at least one of the placed inserts has a discharge opening. As needed, one or more of the inserts can be removed and replaced with a different removable insert.

Typically the device is used for discharging air that contains no liquid, i.e., typically it is not used for spraying liquids.

### DRAWINGS

These and other features, aspects, and advantages of the present invention will become better understood with reference to the following description, appended claims, and accompanying drawings where:

FIG. 1 is a perspective view of an air drying system having features of the present invention being used for drying target pieces;

FIG. 2 shows a first air discharge apparatus usable in the system of FIG. 1 having five different inserts;

FIG. 3 is a schematic view of a portion of a second air discharge apparatus having multiple inserts separated by spacers, the apparatus having features of the present invention;

FIG. 3A is a detailed view of region 3A in FIG. 3;

FIG. 4 is a schematic view of a third air discharge apparatus having features of the present invention;

FIG. 4A is a detailed view of region 4A in FIG. 4;

FIG. 5 is an exploded perspective view of the second version of the air discharge apparatus as shown in FIG. 3;

FIG. 6 is an exploded perspective view of a fourth version of an air discharge apparatus having features of the present invention; and

FIG. 7 is a sectional view of the apparatus of FIG. 5 taken along lines 7-7 in FIG. 5 with the inserts in place.

### DESCRIPTION

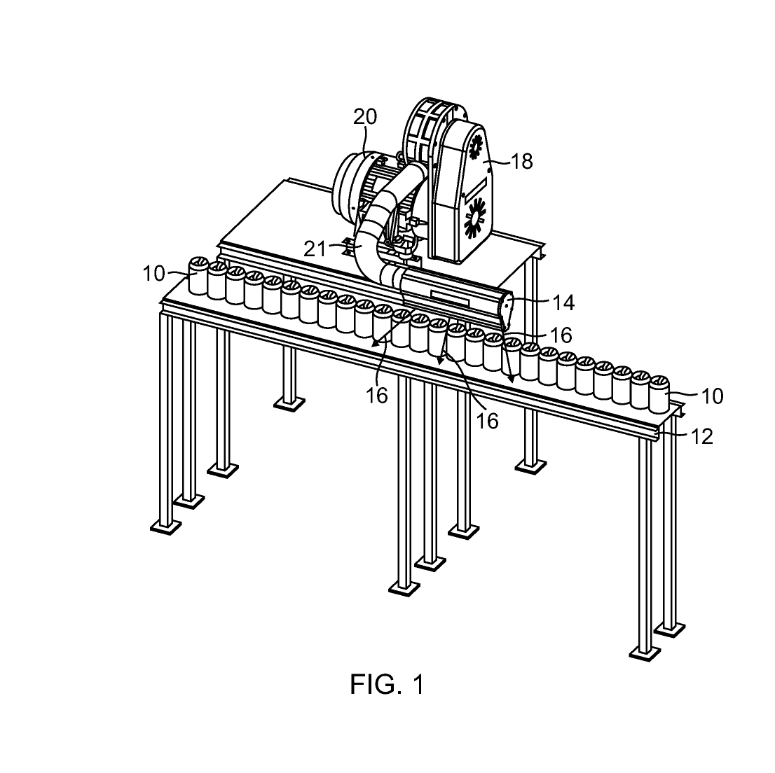

With regard to FIG. 1, target pieces 10 are supported on a support 12 for treatment with air provided by an air discharge apparatus 14 such as an air knife blowing air in a direction such as shown by arrows 16. Air under pressure is provided to the air discharge apparatus 14 by a fan 18 powered by a motor 20, the air passing from the fan 18 to the air discharge apparatus 16 through a duct 21.

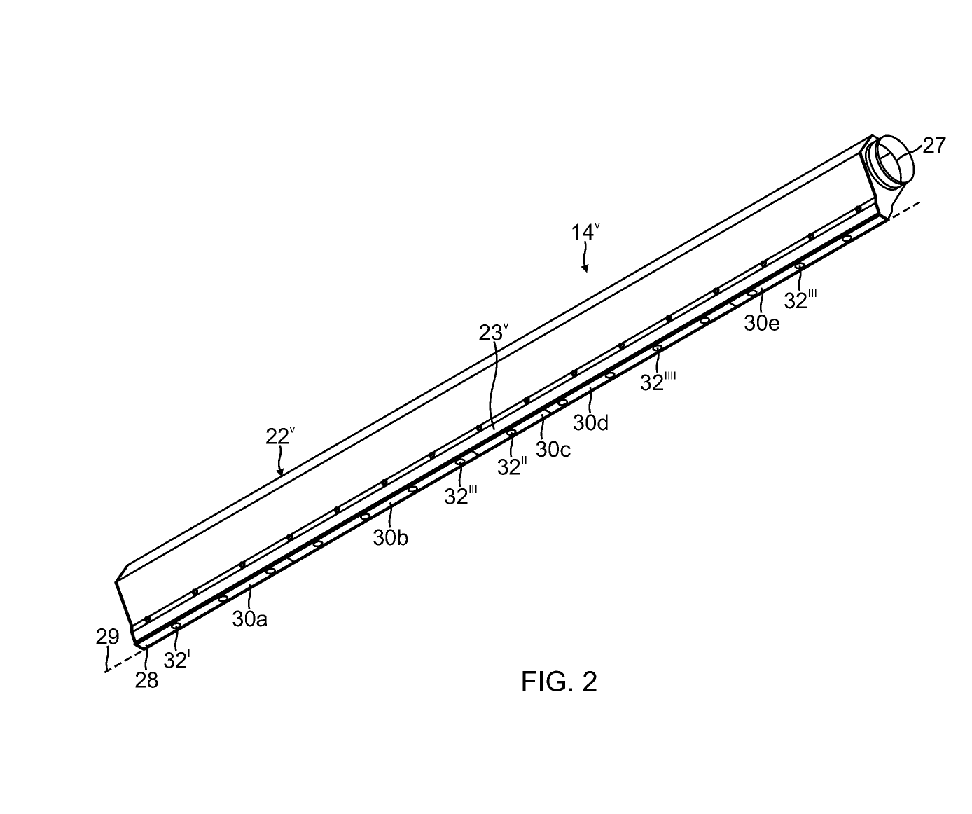

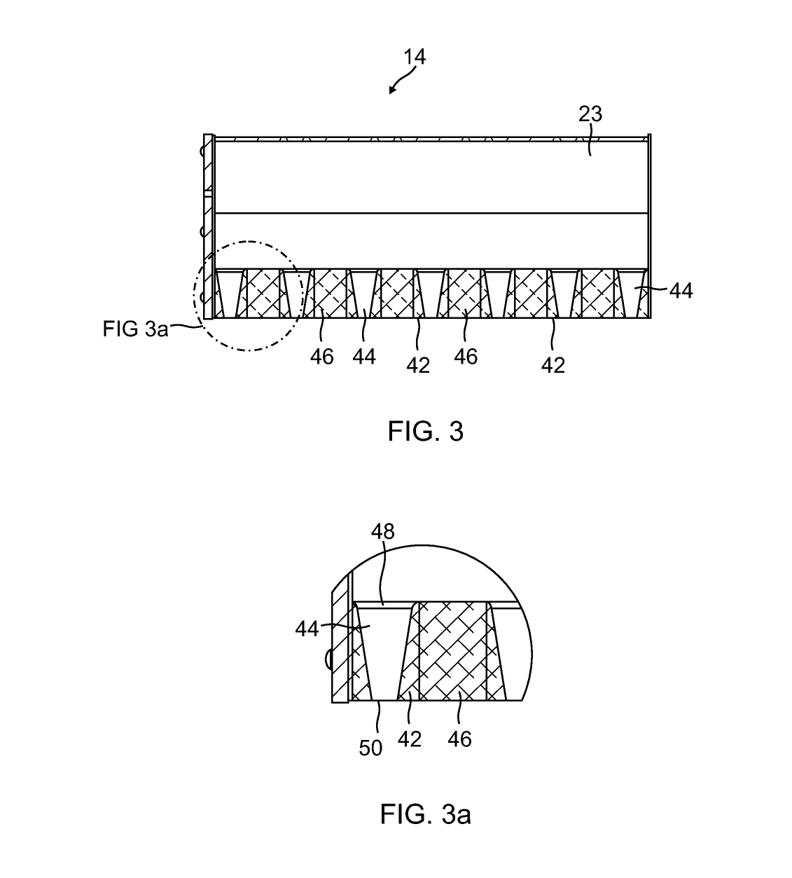

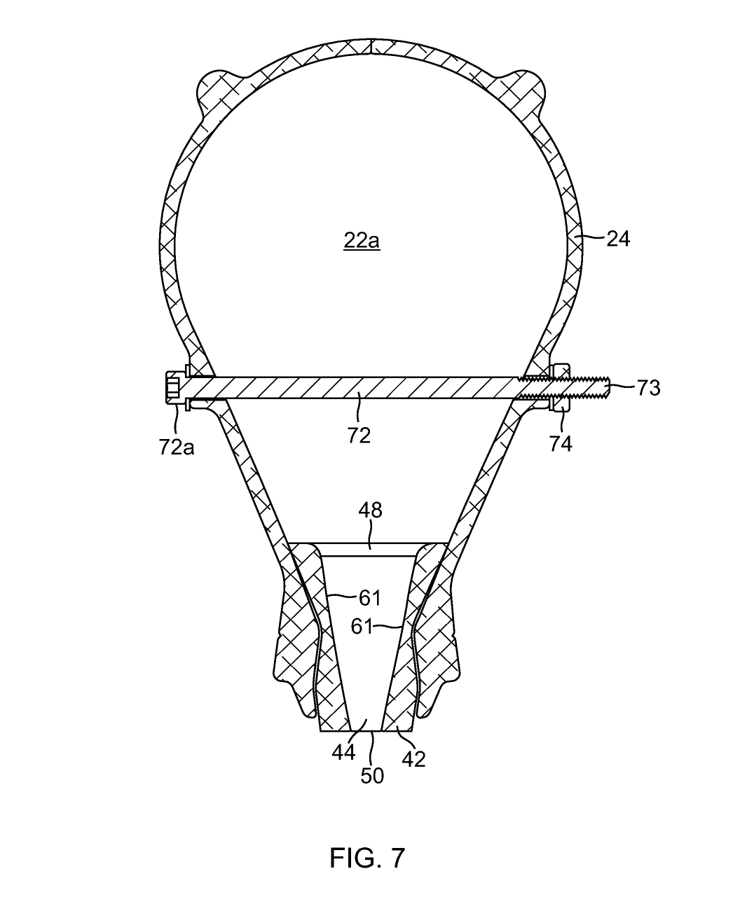

With regard to FIGS. 2 and 3, the air discharge apparatus 14 comprises an enclosure 22 enclosing a plenum 22a (as shown in FIG. 7). The enclosure 22 comprises a main body 23 having an external wall 24 and an open end closed by an end cap 25 secured by fastener 26, an air supply inlet 27 for connection to the duct 21, and an elongated discharge slot 28 having a longitudinal axis 29. The enclosure 22 has a tear drop or pear shape as conventionally used for air knife designs. It can be made from any material conventionally used in air knife designs, such as stainless steel, plastics and aluminum.

There is at least one removeable insert 30 proximate to and typically located at the discharge slot 28, where at least one of the inserts 30 has a discharge opening 32, also referred to as an orifice or nozzle hole. Air can pass through the discharge slot substantially only through the discharge openings 32. In the version of the invention shown in FIG. 2, there are five inserts 30a, 30b, 30c, 30d and 30e, having 4, 3, 1, 4, and 3 discharge openings 32, respectively. Thus different inserts can have a different number of discharge openings. The inserts can be made from any material conventionally used for air knife designs, including stainless steel, aluminum and plastic.

As will be demonstrated from other exemplary versions of the invention, the apparatus 14 can have the following variations of inserts:
1. Only one insert, where that insert has at least one discharge opening.
2. Two or more inserts, where each insert has at least one discharge opening.
3. At least two inserts, where at least one serves as a spacer having no discharge openings.
4. The discharge openings in a single insert, or in different inserts, discharge air in the same direction, or in different directions. For example, discharge opening 32′ can discharge air towards the left in FIG. 2, discharge opening 32″ can discharge air directly straight out, discharge orifice 32′″ can discharge air towards the right, discharge opening 32″″ can discharge air upwardly, and discharge opening 32′″″ can discharge air downwardly. The openings 32 can be oriented to discharge in any direction, such as upwardly and toward the right in FIG. 2. Thus discharge openings 32 can discharge air at the first angle relative to the longitudinal axis 29 where different discharge openings discharge at different angles relative to the longitudinal axis 29.

Optionally there can be a one or more reinforcing bars on the exterior wall.

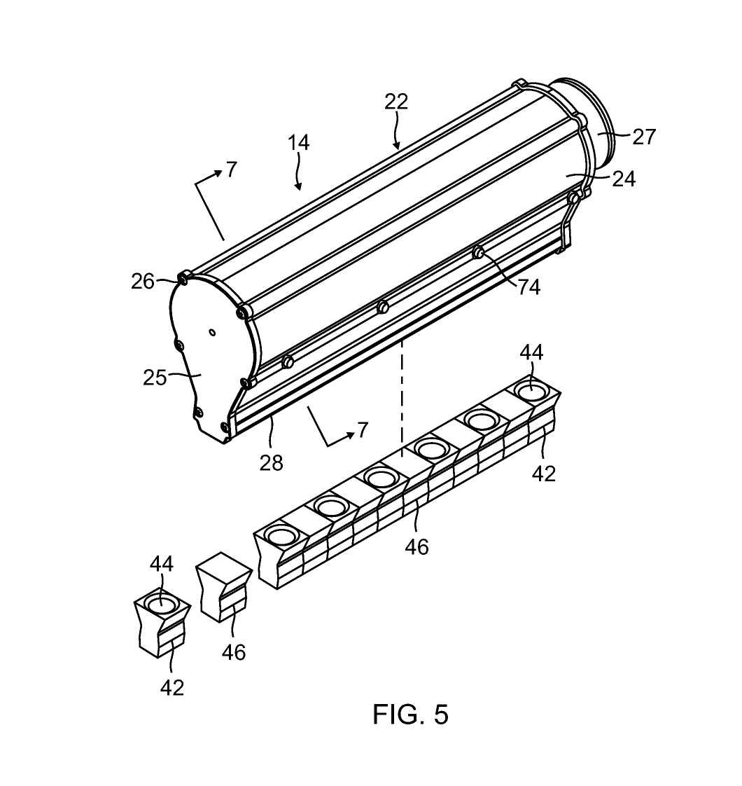

With reference to FIGS. 3 and 5, there is shown a version of the present invention where the air distribution apparatus 14 is provided with ten inserts, seven inserts 42 having a single discharge opening 44, and six spacer inserts 46 having no discharge opening. There is a spacer insert 46 between each pair of discharge inserts 42.

As best shown in FIGS. 3A, 6 and 7, the external wall 24 can be generally tapered toward the discharge slot 28, and the inserts can have a corresponding shape. The inserts are sized to fit between the exterior walls proximate to the discharge slot 28 without being able to fit through the discharge slot 28.

It is desirable that the discharge openings 32 taper, having an inlet end 48 and a discharge end 50, the cross-sectional area of the inlet end 48 being greater than the cross-sectional area of the outlet end 50 so that the velocity of air passing through the discharge opening increases from the inlet end 48 to the outlet end 50. Preferably the inlet end 48 of each discharge opening is about 25% larger in cross sectional areas than the air exit end 50 of each discharge opening, thereby allowing the air to increase in velocity as it approaches the nozzle exit. The exit velocity of air at outlet 50 is about four times greater than the inlet velocity from the air plenum. Most preferably the discharge opening uniformly increases in cross-sectional area from the inlet end 48 to the outlet end 50. This allows the air being discharged to make a gradual transition from the plenum towards the air outlet 50.

Preferably the angle of each nozzle hole 30 through the insert should be between 15 and 20 degrees to achieve maximum efficiency. Thus the sides 61 of the nozzle hole taper inwardly relative to the centerline by about 15 to about 20 degrees toward the outlet end 50. This helps produce low turbulence during air velocity acceleration and deliver a narrow exit air flow pattern to create high impact air velocities at the parts requiring the air.

The pressure of air entering the plenum can be from 0.1 psig to about 100 psig, depending on the pressure rating of the plenum. It is desirable that the apparatus 14 be designed with materials of construction that can withstand twice the maximum expected air pressure.

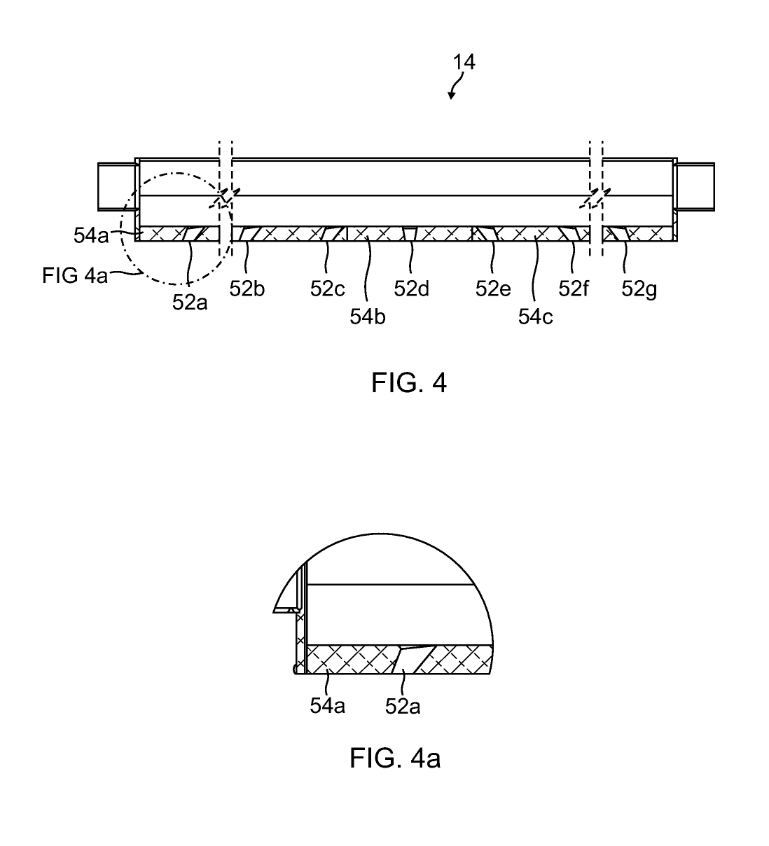

Each insert can be supplied with varying nozzle diameters and angles. The spacer inserts allow for the user to flexibly select a wide variety of nozzle sizes, nozzle angles and nozzle patterns. With reference to FIG. 4, discharge openings 52a, 52b and 52c of insert 54a discharge at the same first angle generally to the left in FIG. 4, the single discharge opening 52d of insert 54b discharges air straight downwardly, and discharge openings 52e, 52f, and 52g of insert 54c discharge air generally towards the right in FIG. 4.

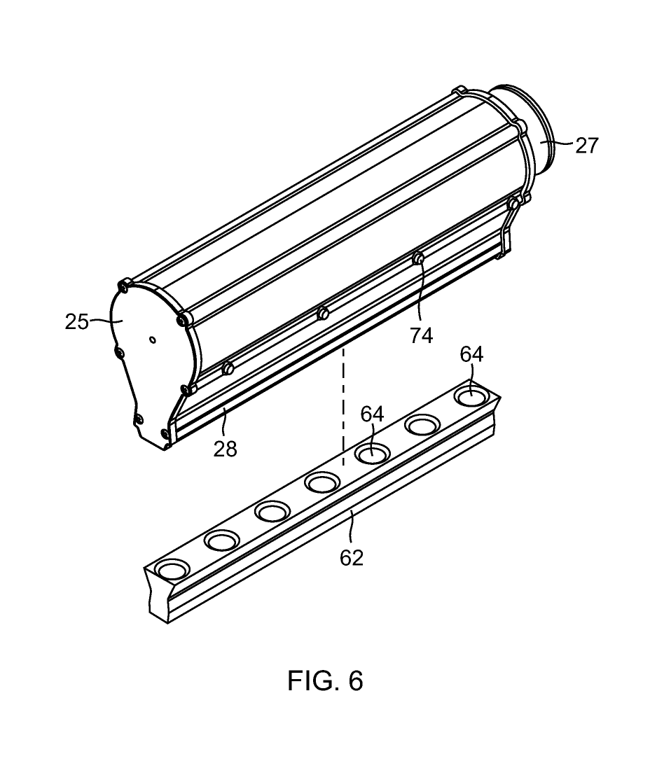

FIG. 6 shows a discharge apparatus 14 having a single insert 62 having ten discharge openings 64.

FIG. 7 shows how the inserts are held in place in a plenum. This is accomplished with a plurality of retaining bars, each having one end with an enlarged head 72a, engageable with an Allen wrench, and a threaded end 73. Each retaining bar extends through openings 24a in the walls 24 of the enclosure and is held in place with a nut 74 on the threaded end 73 of the retaining bar 72, also referred to as a retention clamp 72. The bars 72 squeeze the opposing walls of the enclosure together to hold the inserts within the plenum, thus preventing air leaks between the plenum and the inserts. Merely by loosening the nut 74, and removing the retaining bar 72, the inserts can be replaced with different inserts depending upon the requirements of the application for the apparatus. Accordingly, by the term “removeable” with regard to the inserts there is meant an insert that can be moved from, and thus replaced, in the discharge slot, merely by simple mechanical means. This is to distinguish from conventional air discharge openings or nozzle that are formed integral with the air distribution enclosure, or welded in place, or held in place by an adhesive or solder, or rivets, or the like. Thus a removable insert can be taken away from the enclosure without damaging the enclosure. This is also different from threaded air nozzles which are not in the discharge slot.

The number of bars 72 depends on the length and width of the plenum as well as the air pressure rating itself. Typically there is one retaining bar 72 for each 4″ of air plenum length and retaining bars 72 in parallel across the entire length of the plenum.

In use of the distribution apparatus 14, when it is desired to change the air distribution, one ore more of the existing inserts can be replaced, and with a different removable insert. In some instances, all of the placed inserts can be replaced with different removeable inserts.

There are significant advantages associated with the present invention. It is smaller than prior art distribution apparatus when comparing the same number of air nozzles as long as the air volume rating is at least 50% as much as the air plenum with nozzles in the present invention. It utilizes modular components for quick and easy assembly of each manifold with a wide variety of nozzle sizes, nozzle angles, nozzle center distances, and number of nozzles per manifold. Due to the compact size and high air efficiency, the modular assembly is very effective in operation.

Although the present invention is has been described in considerable detail with reference to certain preferred versions thereof, other versions are possible. Therefore the claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (Including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, ¶916. In particular, the use of “step of” in the claim herein is not intended to invoke the provisions of 35 U.S.C. §112, ¶916.

1-23. (canceled)

24. An apparatus for directing pressurized air comprising:
a) an enclosure for receiving pressurized air, the enclosure including an external wall, the external wall defined by an end cap and a second end comprising an air supply inlet, and an elongated discharge slot bounded by the external wall;
b) at least one removable insert, the at least one removable insert positioned within the elongated discharge slot for directing pressurized air outwardly from the enclosure; and
c) at least one air supply inlet, the at least one air supply inlet suitably attached to the second end for directing pressurized air into the enclosure.

25. The apparatus of claim 24 wherein the second end comprises at least one attachment mechanism.

26. The apparatus of claim 24 wherein the end cap and the second end have a general tear drop shape.

27. The apparatus of claim 24 wherein the at least one removable insert is positioned within the elongated discharge slot by means of at least one retaining bar.

28. The apparatus of claim 24 wherein the at least one removable insert comprises at least one discharge opening, the at least one discharge opening tooled vertically into the at least one removable insert.

29. The apparatus of claim 24 wherein the enclosure is formed as a single element using a suitable forming process.

30. The apparatus of claim 27 wherein the at least one retaining bar for positioning the at least one removable insert within the elongated discharge slot is comprised of at least one nut.

31. The apparatus of claim 27 wherein the external wall further comprises at least one opening for receiving the at least one retaining bar for securing the at least one removable insert.

32. An apparatus for directing pressurized air comprising:
a) an enclosure for receiving pressurized air, the enclosure including an external wall, the external wall defined by an end cap and a second end comprising an air supply inlet, wherein the second end comprises at least one attachment mechanism, and an elongated discharge slot bounded by the external wall;
b) at least one removable insert configured so as to fully occupy the elongated discharge slot, the at least one removable insert positioned within the elongated discharge slot by means of at least one retaining bar, the at least one retaining bar including at least one nut, the at least one removable insert further including at least one discharge opening for directing pressurized air outwardly from the enclosure, the at least one discharge opening tooled vertically into the at least one removable insert; and
c) at least one air supply inlet, the at least one air supply inlet comprised of a circular pipe suitably attached to the second end for directing pressurized air into the enclosure.

33. The apparatus of claim 32 wherein the at least one removable insert comprises at least two discharge openings for directing the pressurized air outwardly from the enclosure.

34. The apparatus of claim 32 wherein the at least one removable insert comprises at least two discharge openings for directing the pressurized air outwardly from the enclosure, wherein the at least two discharge openings have the same diameter and are tooled vertically into the at least one removable insert.

35. The apparatus of claim 32 wherein the at least one removable insert comprises at least two discharge openings for directing the pressurized air outwardly from the enclosure, wherein the at least two discharge openings have different diameters and are tooled vertically into the at least one removable insert.

36. The apparatus of claim 32 wherein the at least one removable insert comprises at least two discharge openings for directing the pressurized air outwardly from the enclosure, wherein the at least two discharge openings are tooled at an angle into the at least one removable insert.

37. The apparatus of claim 32 wherein the enclosure is formed as a single element using a suitable forming process.

38. The apparatus of claim 37 wherein the at least one removable insert further comprises at least two discharge openings, the at least two discharge openings comprising different diameters for directing pressurized air outwardly from the enclosure.

39. The apparatus of claim 38 wherein the at least two discharge openings are tooled vertically into the at least one removable insert.

40. The apparatus of claim 38 further comprising a fan powered by a motor, the fan for supplying pressurized air into the enclosure through the at least one air inlet.

41. The apparatus of claim 38 further comprising at least two removable inserts configured so as to fully occupy the elongated discharge slot, the at least two removable inserts positioned within the elongated discharge slot by means of at least two retaining bars, the at least two retaining bars including at least two nuts and the at least two removable inserts including at least two discharge openings, the at least two discharge openings comprising different diameters for directing pressurized air outwardly from the enclosure; and
d) a fan powered by a motor, the fan for supplying pressurized air into the enclosure through the at least one air inlet.

42. The apparatus of claim 41 wherein the at least two discharge openings are tooled at an angle into at least one of the at least two removable inserts.

43. A method for optimizing an air stream for pressurized air being directed toward objects comprising:
selecting an apparatus to direct a pressurized air stream at objects to be dried, cleaned or cooled;
attaching the apparatus to a fan by an attachment mechanism on a second end;
replacing at least one removable insert by removing at least one retaining bar from openings on an external wall;
removing the at least one removable insert from a discharge opening;
positioning another at least one removable insert into the discharge opening so as to fully occupy the discharge opening;
inserting the at least one retaining bar into and through the openings located on the external wall; and
securing the at least one retaining bar to the external wall.
